(19) United States
(12) Patent Application Publication
(10) Pub. No.: US 2021/0204613 A1
(43) Pub. Date: Jul. 8, 2021

(54) MULTI-CHAMBER CARTRIDGE FOR VAPING DEVICE AND VAPING DEVICE CONFIGURED TO OPERATE WITH MULTI-CHAMBER CARTRIDGE

(71) Applicant: Frank Gatski, Las Vegas, NV (US)

(72) Inventor: Frank Gatski, Las Vegas, NV (US)

(21) Appl. No.: 17/203,401

(22) Filed: Mar. 16, 2021

Related U.S. Application Data
(63) Continuation of application No. 16/389,814, filed on Apr. 19, 2019, now abandoned.

(51) Int. Cl. A24F 40/60; H05B 3/42; A24F 40/42

(52) U.S. Cl. CPC A24F 40/60; A24F 40/42; H05B 3/42

(57) ABSTRACT

A vape device cartridge having multiple chambers each for holding a substance to be vaped. The multi-chamber being attachable to a vape device having at least a housing and battery. A vape device or cartridge may include multiple selectable heating elements. An interface may permit a user to select a desired one or more heating elements to activate such a desired substance or substances are vaped. A processor may be used to control certain features of the vape device and multi-chamber cartridge.

### CROSS-REFERENCE

This application is a continuation of U.S. patent application Ser. No. 16/389,814 filed Apr. 19, 2019 which is incorporated herein for all purposes.

### FIELD OF THE INVENTION

The embodiments of the present invention relate to a multi-chamber cartridge for use with a vaping device and a vaping device configured to operate with said multi-chamber cartridge.

### BACKGROUND

Vaping devices (e.g., e-cigs, vape pens, vaporizers, etc.) have become very popular. Claims of being safer than conventional cigarettes, ease of use and the variety of flavors and substances that can be inhaled are all selling points. As detailed herein, most of the vaping devices work on the same principle. However, one drawback to vaping devices is the need to change cartridges each time a user wants to change the flavor or substance to be vaped.

It would be advantageous to develop a multi-chamber cartridge that may contain multiple unique flavors or substances to be vaped. Moreover, the multi-chamber cartridge should be configured for use with vaping devices such that a user is able to select between two or more flavors or substances to vape, including combinations thereof.

### SUMMARY

Accordingly, a first embodiment of the present invention comprises a vape device cartridge having two or more chambers each configured to hold a substance to be vaped; said vape device cartridge configured to be attached to a vaping device such that each of said two or more chambers are: (i) in communication with two or more heating elements of said vaping device or (ii) said vape device cartridge may be moved between multiple orientations to position each of said two or more chambers into communication with a single heating element of said vaping device.

In one embodiment, the multi-chamber cartridge may be rotated relative to the vaping device to position each of said two or more chambers into communication with a single heating element of said vaping device. In another embodiment, the vaping device includes multiple heating elements from the which the user may select to activate. Regardless of the embodiment, a user is able to select from multiple flavors or substances without having to change the vaping device cartridge.

Other variations, embodiments and features of the present invention will become evident from the following detailed description, drawings and claims.

### BRIEF DESCRIPTION OF THE DRAWINGS

FIG. 1 illustrates a cut-away view of an exemplary vaping device according to the prior art;

FIG. 2A illustrates a side view of a second exemplary vaping device according to the prior art;

FIG. 2B illustrates a front view of a second exemplary vaping device according to the prior art;

FIG. 2C illustrates a cut-away view of a second exemplary vaping device according to the prior art;

FIG. 3 illustrates an exploded view of a third exemplary vaping device according to the prior art;

FIG. 4A illustrates a side view of a multi-chamber cartridge according to the embodiments of the present invention;

FIG. 4B illustrates a top down view of a multi-chamber cartridge according to the embodiments of the present invention;

FIG. 5A illustrates an internal view of an exemplary multi-chamber cartridge in place on a vape device according to the embodiments of the present invention

FIG. 5B illustrates the internal view of the exemplary multi-chamber cartridge in place on a vape device of FIG. 5A with a switch moved according to the embodiments of the present invention

FIG. 5C illustrates an exemplary exterior view of the multi-chamber cartridge in place on a vape device of FIGS. 5A and 5B according to the embodiments of the present invention

FIG. 6A illustrates an interior view of an exemplary rotating multi-chamber cartridge in place on a vape device in a first position according to the embodiments of the present invention;

FIG. 6B illustrates an interior view of the exemplary rotating multi-chamber cartridge in place on a vape device of FIG. 6A in a second position according to the embodiments of the present invention;

FIG. 6C illustrate an underside view of a cartridge of the exemplary rotating multi-chamber cartridge in place on a vape device of FIGS. 6A and 6B according to the embodiments of the present invention;

FIG. 7 illustrates an exemplary multi-chamber cartridge with a single heating element in place on a vape device according to the embodiments of the present invention; and

FIG. 8A illustrates an internal view of an exemplary multi-chamber cartridge having five chambers according to the embodiments of the present invention

FIG. 8B illustrates an exterior view of an exemplary vape device configured to retain the multi-chamber cartridge having five chambers of FIG. 8A according to the embodiments of the present invention

FIG. 8C illustrates a top down view of the exemplary multi-chamber cartridge having five chambers of FIG. 8A according to the embodiments of the present invention; and

FIG. 8D illustrates a cut-away view of the vape device of FIG. 8B retaining the exemplary multi-chamber cartridge having five chambers of FIG. 8A according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The components of the present invention may be made using any suitable materials including, but not limited to, alloys, composites, metals, polymers, ceramics, plastics and combinations thereof. The components of the present invention may be fabricated using any suitable technique including, but not limited to, milling, machining, molding, casting, 3D printing and combinations thereof. As used herein, vaping devices include e-cigs, vape pens, vaporizers and any other device for vaporizing a liquid or substance to create vapors to be inhaled and exhaled by a user.

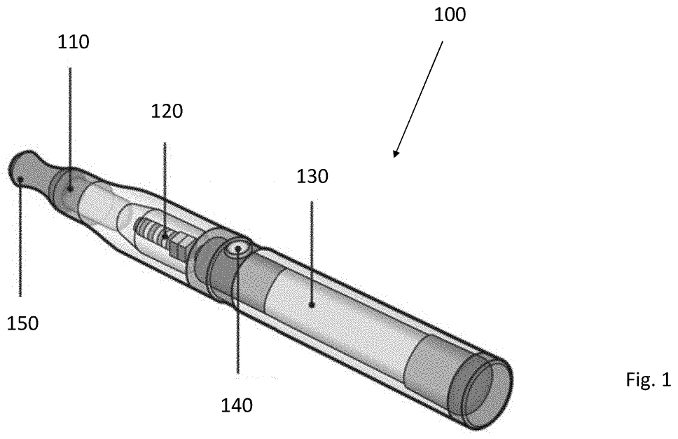

FIG. 1 shows a cut-away of a first exemplary vaping device 100 of the prior art. A vaping device 100 generally includes a tank or chamber 110 for receiving the substance to be vaped, a heating element or atomizer 120 for vaporizing the substance to be vaped; a battery 130 for powering the atomizer 120; a button 140 or other interface for a user to activate said atomizer 120 and a mouthpiece 150 through which the vapors, created by the atomizer 120 working on the substance, are inhaled.

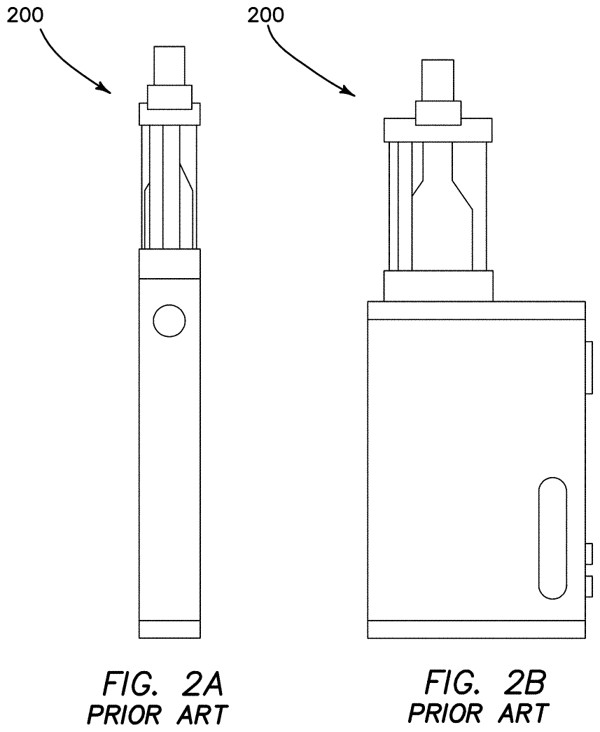

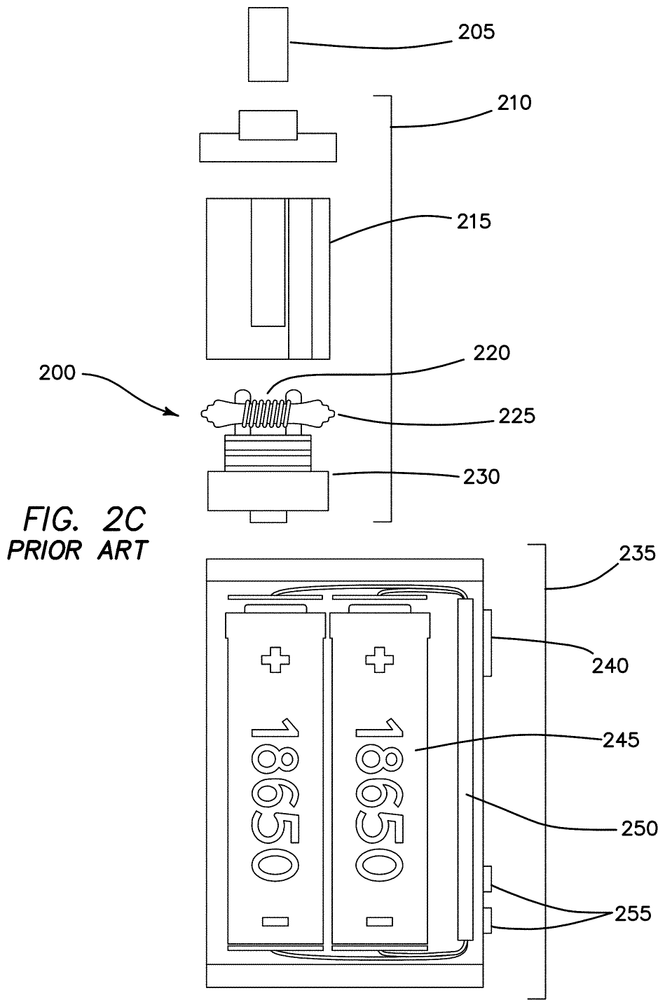

FIGS. 2A through 2C show a side view, front view and cut-away view of a second exemplary vaping device 200 according to the prior art. The vaping device 200 includes a mouthpiece 205, tank 210 comprising of an e-liquid reservoir 215, coils 220, cotton wick 225 and atomizer 230 and mod box 235 comprising an activation button 240, battery 245, control chip 250 and control button 255.

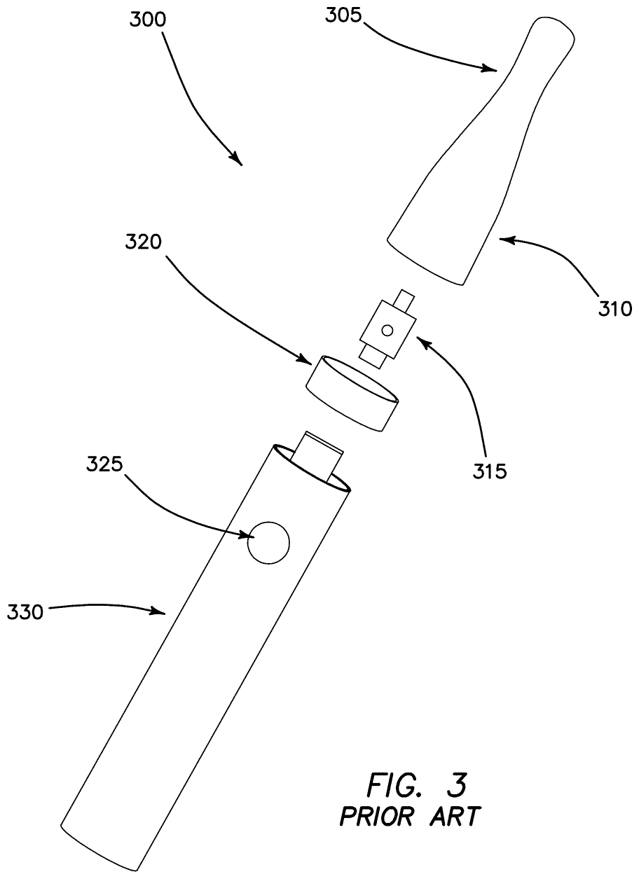

FIG. 3 shows an exploded view of a third exemplary vaping device 300 according to the prior art. The vaping device 300 includes a mouthpiece 305, tank 310, coil 315, base section 320, activation button 325 and battery compartment 330.

Smart vape devices may include other components such as processors and sensors for carrying out any number of functions including monitoring when the vape device needs to be cleaned, re-filled, switching compartments, etc. Digital displays may also be integrated into the vape devices to provide relevant information to the user.

As evidenced from the vaping devices 100, 200 and 300 detailed above, a vaping device utilizes a battery-powered heating element to vaporize a liquid within a cartridge to create a vapor. In each instance, the liquid cartridge or chamber holds a single liquid. Accordingly, when a user desires to use a different liquid, the user must switch out the cartridge attached to the vaping device with a new cartridge containing a different liquid. Such vaping devices are tedious to use and not sufficiently versatile. Therefore, the embodiments of the present invention involve the use of a multi-chamber cartridge. For purposes of brevity, a two-chamber cartridge is detailed below, but the cartridge according to the embodiments of the present invention may include more than two chambers. Moreover, the chambers may contain a liquid or solid substance as desired.

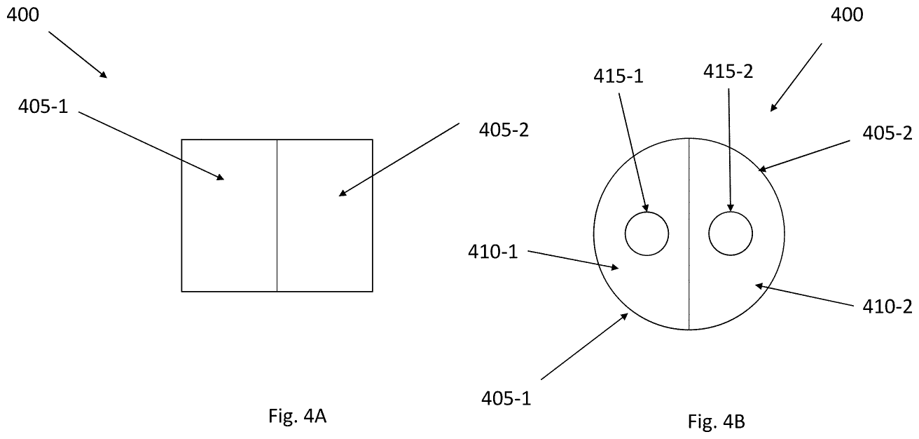

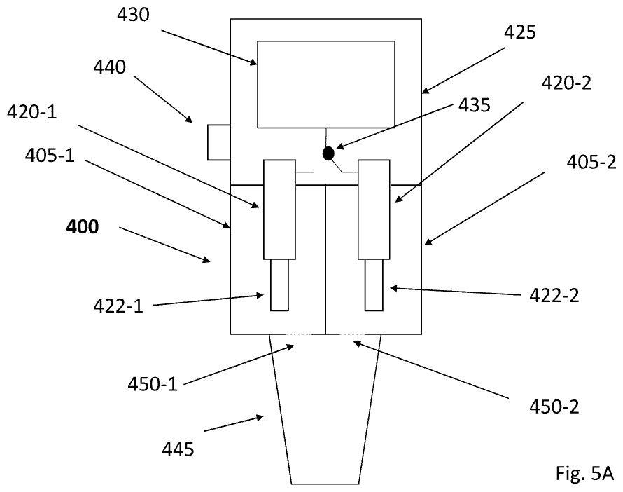

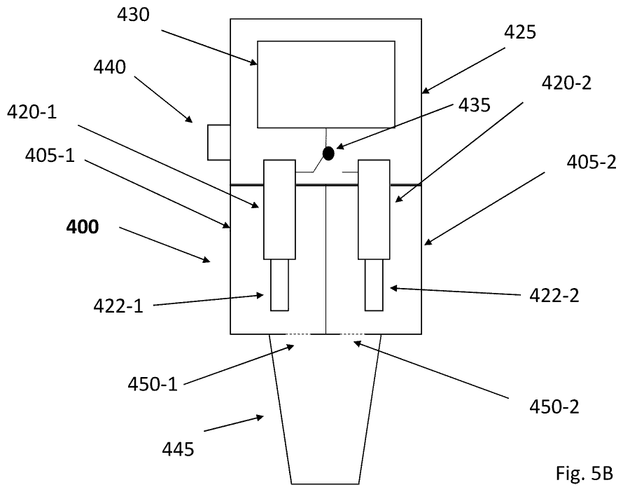

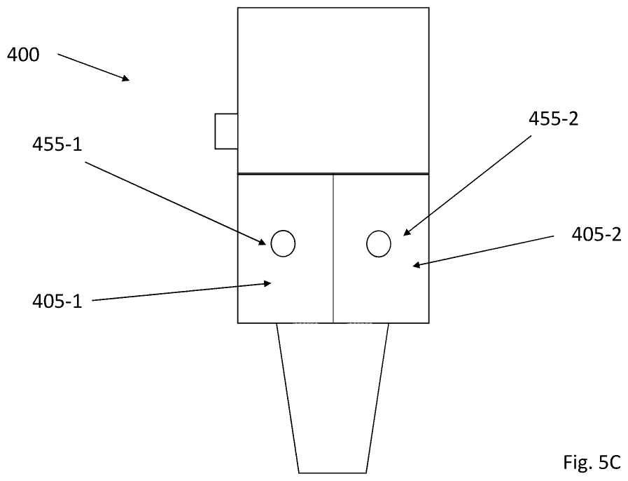

FIGS. 4A and 4B show side and top down views of a multi-chamber cartridge 400 according to the embodiments of the present invention. As shown, each chamber 405-1, 405-2 includes an opening 410-1, 410-2 in a top 415-1, 415-2 thereof. The openings 410-1, 410-2 are configured to receive heating elements 420-1, 420-2 (e.g., coils) integral with the vape device 425 as shown in FIG. 5A. Alternatively, the heating elements may be integral with the multi-chamber cartridge 400 and plug into corresponding cavities in the vape device. In this manner, the multi-chamber cartridge 400 acts as an atomizer device. The openings 410-1, 410-2 may also be used to fill the chambers 405-1, 405-2 as needed. The heating elements 420-1, 420-2 communicate with wicks 422-1, 422-2 to draw liquids in said compartments 405-1, 405-2 to said heating elements 420-1, 420-2. Switch 435 toggles power between the two heating elements 420-1, 420-2 via an interface 440 (e.g., button) on the vape device 425. The switch 435 may be controlled by a simple circuit between the interface 440 and the switch 435 or a processor may control the switch 435 based on receipt of an input signal by the user. Thus, the user is able to select which fluid to vaporize and inhale. FIG. 5A shows chamber 405-2 selected and FIG. 5B shows chamber 405-1 selected. One-way openings 450-1, 450-2 provide means for vapers to pass from either chamber 405-1, 405-2 to the mouthpiece 445 for inhalation by the user.

FIG. 5C shows a pair of LEDs 455-1, 455-2 which notify the user which chamber 405-1, 405-2 is selected for vaping. As shown, each chamber 405-1, 405-2 has one of the LEDs 455-1, 455-2 positioned thereon such that when illuminated the respective chamber 405-1, 405-2 is the selected chamber. Other means, including illuminated arrows, numeric indicators, etc., may be used to denote which chamber 405-1, 405-2 has been selected.

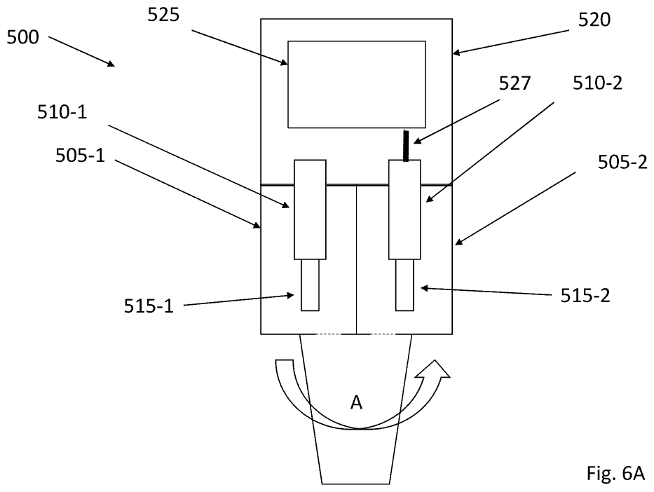

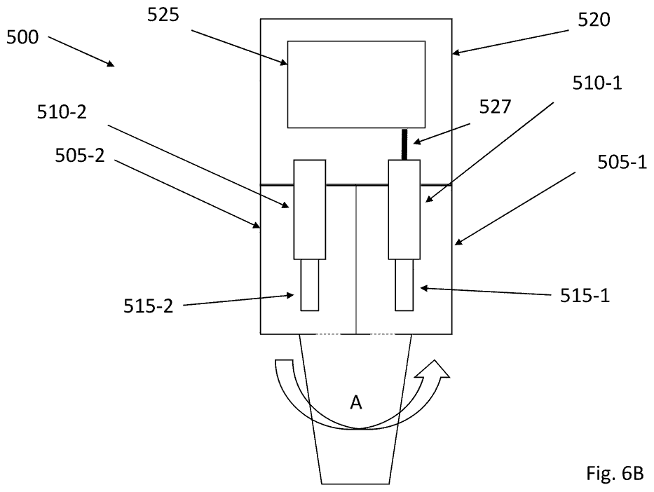

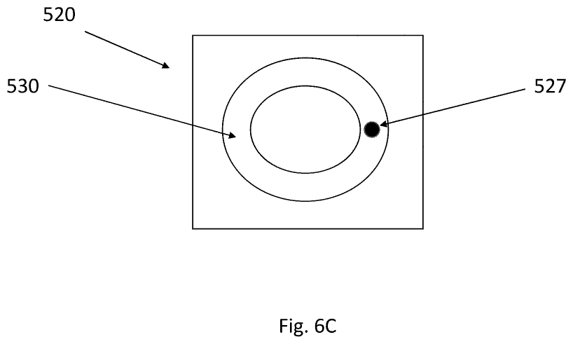

In another embodiment shown in FIGS. 6A and 6B, a multi-chamber cartridge 500 incorporates a pair of chambers 505-1, 505-2, heating elements 510-1, 510-2 and wicks 515-1, 515-2. Rather than using the switch 435 shown in FIGS. 5A and 5B, in this embodiment, the multi-chamber cartridge 500 rotates about a vape device 520 and battery 525 so that one of the heating elements 510-1, 510-2 comes into contact with the output lead 527 of the battery 525. As shown, the multi-chamber cartridge 500 rotates in the direction shown by arrow A. FIG. 6A shows the multi-cartridge 500 with chamber 505-2 selected while FIG. 6B shows the multi-chamber cartridge 500 rotated such that chamber 505-1 is now the selected chamber. In one embodiment, the heating elements 510-1, 510-2 rotate within a circular cavity 530 in an underside of the vape device 520 and lock in place when in contact with the output lead 527.

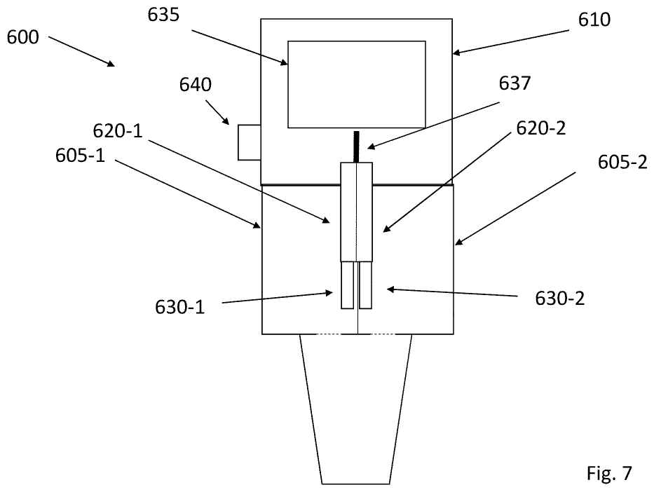

FIG. 7 shows an exemplary multi-chamber cartridge 600 with a single heating element 605 in place on a vape device 610 according to the embodiments of the present invention. In this embodiment, the heating element 615 has two halves 620-1, 620-2 with one half in each chamber 625-1, 625-2. Each half 620-1, 620-2 includes a wick 630-1, 630-2. Lead 637 carries energy from the battery 635 to the heating element 610. Button 640 controls the selection of chamber 625-1, 625-2 and the heating element half 620-1, 620-2 which activates.

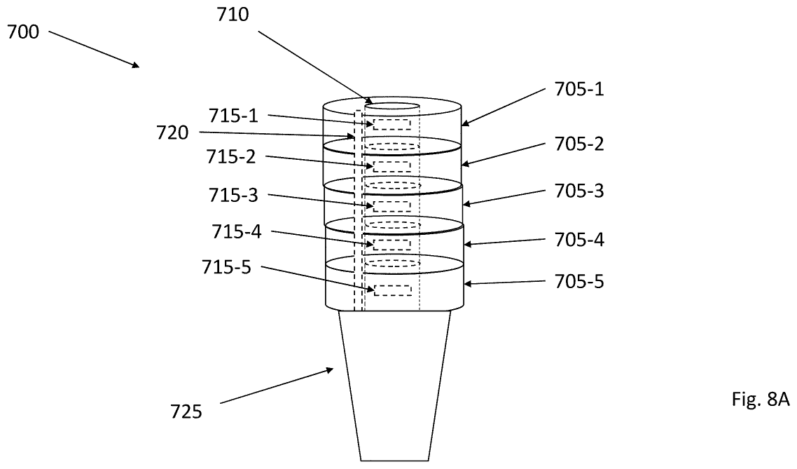

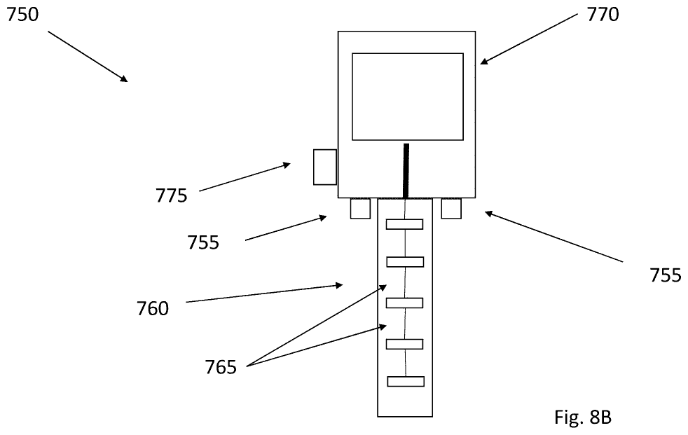

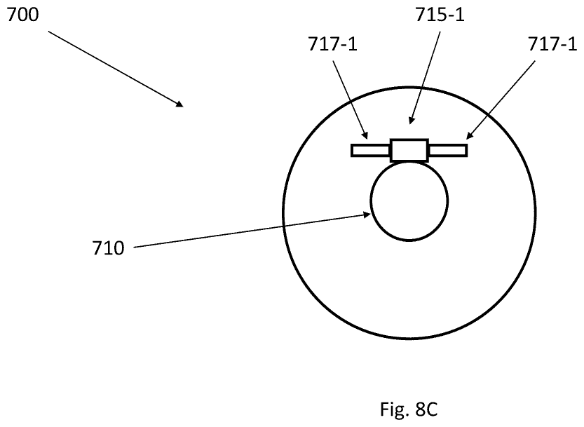

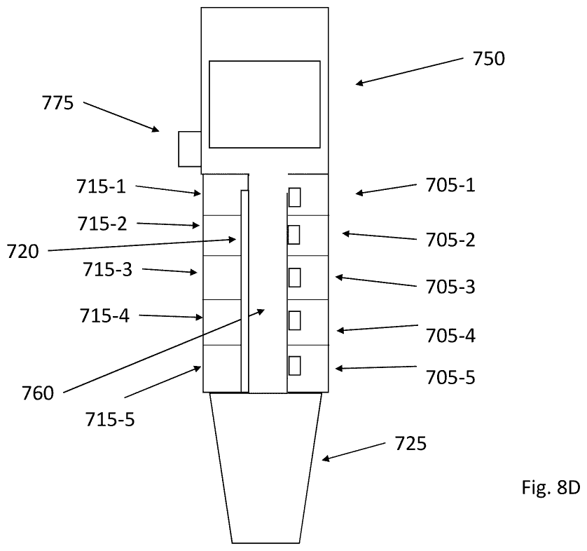

FIGS. 8A and 8C illustrate an exemplary multi-chamber cartridge 700 having five chambers 705-1 through 705-5 according to the embodiments of the present invention. A circular opening 710 extends through the center of the multi-chamber cartridge 700. Each chamber 705-1 through 705-5 includes a heating element 715-1 through 715-5 and wicks. A vapor passageway 720 is in communication with each chamber 705-1 through 705-5 to carry vapors from a selected chamber 705-1 through 705-5 to a mouth piece 725. FIG. 8B shows a vape device 750 configured to receive the multi-chamber cartridge 700. In one embodiment, two pins 755 in the vape device 750 receive the multi-chamber cartridge 700. Other fastening means may be used to attach the multi-chamber cartridge 700 to the vape device 750. Post 760 is configured to extend through opening 710 such that battery leads 765 attach the battery 770 to the heating elements 715-1 through 715-5. A button 770 or other interface permits the user to select a which heating element 715-1 through 715-5 to activate. In one embodiment, the user may select multiple heating elements 715-1 through 715-5 to generate mixed vapors. As set forth above, a processor may be used to control chamber selection caused by said interface 775.

FIG. 8C shows a top down view of the multi-chamber cartridge 700 such that the interior of chamber 705-1 is viewable. Heating element 715-1 retains a wick 717-1 in a manner consistent with each chamber 705-1 through 705-5. FIG. 8D shows a cut-away side view of the vape device 750 with the exemplary multi-chamber cartridge 700 in place.

Although the invention has been described in detail with reference to several embodiments, additional variations and modifications exist within the scope and spirit of the invention as described and defined herein.

I claim:

1. A vape device comprising:
a housing;
a battery within said housing;
a cartridge comprising two or more chambers each configured to hold a substance to be vaped;
at least one heating element configured to vaporize said substances in said two or more chambers;
an electronic interface configured to allow selection of a chamber from which said substance is vaporized; and
and a mouth piece in communication with each of said two or more chambers.

2. The vape device of claim 1 further comprising a display device.

3. The vape device of claim 1 further comprising a processor running executable instructions.

4. The vape device of claim 1 wherein said at least one heating element is divided between said two or more chambers.

5. The vape device of claim 1 wherein said heating element supports two or more wicks.

6. A vape device comprising:
a housing;
a battery within said housing;
a cartridge comprising two or more chambers each configured to hold a substance to be vaped, said cartridge further comprising a heating element for each of said two or more chambers;
a mouth piece in communication with each of said two or more chambers; and
wherein said cartridge is rotatably attached to said housing such that a user may connect a desired heating element to said battery by rotating said cartridge.

7. The vape device of claim 6 wherein said housing further includes a circular cavity for guiding rotation of said cartridge.

8. A vape device comprising:
a housing including an elongated post;
a battery within said housing;
a cartridge comprising two or more chambers each configured to hold a substance to be vaped, said cartridge further comprising a heating element for each of said two or more chambers, said two or more chambers stacked upon one another and having a central opening therethrough, said central opening for receiving said elongated post to attach said cartridge to said housing;
a mouth piece in communication with each of said two or more chambers;
an interface configured to allow selection of one or more heating elements to activate; and
wherein said elongated post further includes leads positioned to power said heating elements via said battery.

9. The vape device of claim 8 further comprising a display device.

10. The vape device of claim 8 further comprising a processor running executable instructions.
